(19) United States
(12) Patent Application Publication
(10) Pub. No.: US 2011/0235362 A1
(43) Pub. Date: Sep. 29, 2011

(54) LIGHT CONCENTRATION DEVICE AND RELATED BACKLIGHT MODULE

(75) Inventor: HO-CHIANG LIU, Tu-Cheng (TW)

(73) Assignee: HON HAI PRECISION INDUSTRY CO., LTD., Tu-Cheng (TW)

(21) Appl. No.: 12/894,119

(22) Filed: Sep. 29, 2010

(30) Foreign Application Priority Data
Mar. 29, 2010 (TW) 99109341

(51) Int. Cl. F21V 7/22

(52) U.S. Cl. 362/606; 362/609

(57) ABSTRACT

A light concentration device includes a light concentration plate. The light concentration plate has a first surface and a second surface facing away from the first surface. The light concentration plate defines a number of through holes running through the first surface and the second surface. The light concentration plate has a number of inner surfaces in the respective through holes. Each of the through holes tapers from the second surface to the first surface. The inner surfaces and at least one of the first and second surfaces are reflective surfaces.

### BACKGROUND

1. Technical Field

The disclosure relates generally to a light concentration device and a related backlight module.

2. Description of Related Art

A liquid crystal display (LCD) apparatus may include a backlight module and an LCD panel. The backlight module is used to illuminate the LCD panel. The LCD panel includes two light-pervious plates and an LC layer sandwiched between the two light-pervious plates.

Referring to FIG. 11, a typical backlight module 100 includes a casing 11, a number of light sources 12 received in the casing 11, a diffusing plate 13 and a prism sheet 10. The casing 11 has an opening 112. The diffusing plate 13 and the prism sheet 10 are sequentially arranged one on top of the other at the opening 112. The prism sheet 10 has a light incident surface 101 and an opposite light output surface 103. A number of parallel prisms 105 are formed on the light output surface 103. Light emitted from the light sources 12 is diffused by the diffusing plate 13, and then is concentrated by the prism sheet 10, thereby enhancing uniformity, and brightness.

Referring to FIG. 12, light output from the diffusing plate 13 is transmitted through the prisms 105 of the prism sheet 10. Some of the light (such as light rays a1, a2) are concentrated toward an axis perpendicular to the light incident surface 101 (i.e. the Y axis) in respect to its previous transmission direction. However, some of the light (such as light rays a3, a4) will pass away from the Y axis in respect to its previous transmission direction. Thus, the backlight module 100 has a large viewing angle, and cannot meet the requirement of concentration light in a small viewing angle.

Therefore, a light concentration device and a backlight module having a small viewing angle are needed.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the views.

FIG. 1 is a schematic, isometric view of a light concentration device in accordance with a first exemplary embodiment.

FIG. 2 is a schematic, disassembled isometric view of the light concentration device of FIG. 1.

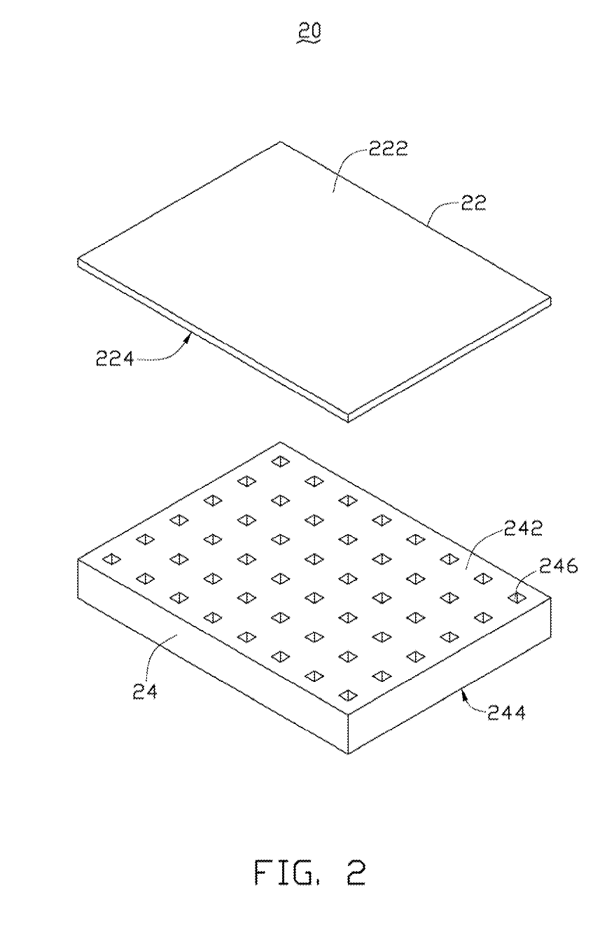

FIG. 3 is a sectional view taken along line III-III of FIG. 1.

FIG. 4 is a sectional view of a light concentration device in accordance with a second exemplary embodiment.

FIG. 5 is a sectional view of a light concentration device in accordance with a third exemplary embodiment.

FIG. 6 is a sectional view of a light concentration device in accordance with a fourth exemplary embodiment.

FIG. 7 is a sectional view of a backlight module in accordance with a fifth exemplary embodiment.

FIG. 8 shows light paths in the backlight module of FIG. 7.

FIG. 9 is a graph of the light intensity distribution of light output from the backlight module of FIG. 7.

FIG. 10 is a sectional view of a backlight module in accordance with a sixth exemplary embodiment.

FIG. 11 is a sectional view of a conventional backlight module.

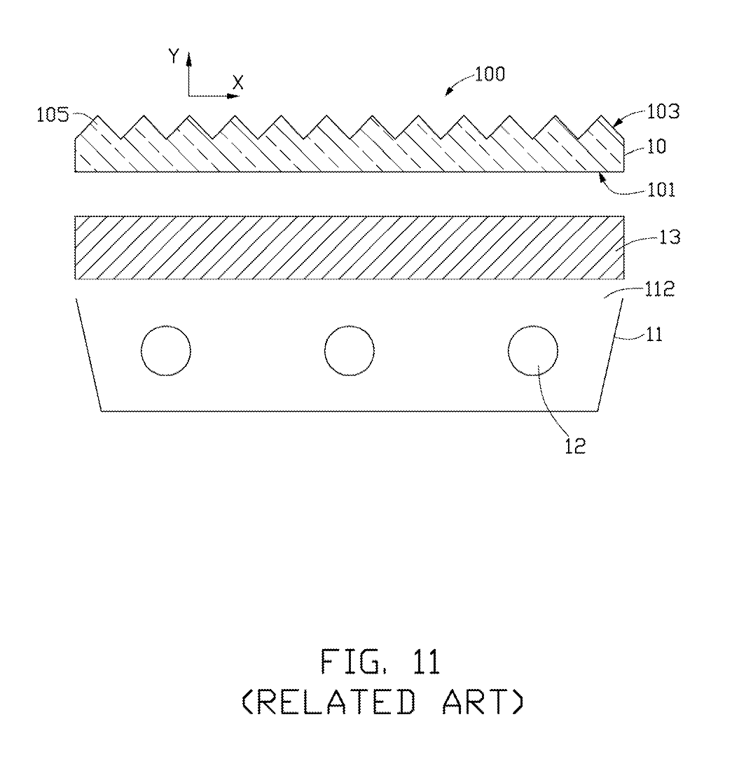

FIG. 12 shows light paths in a prism sheet of the backlight module of FIG. 11.

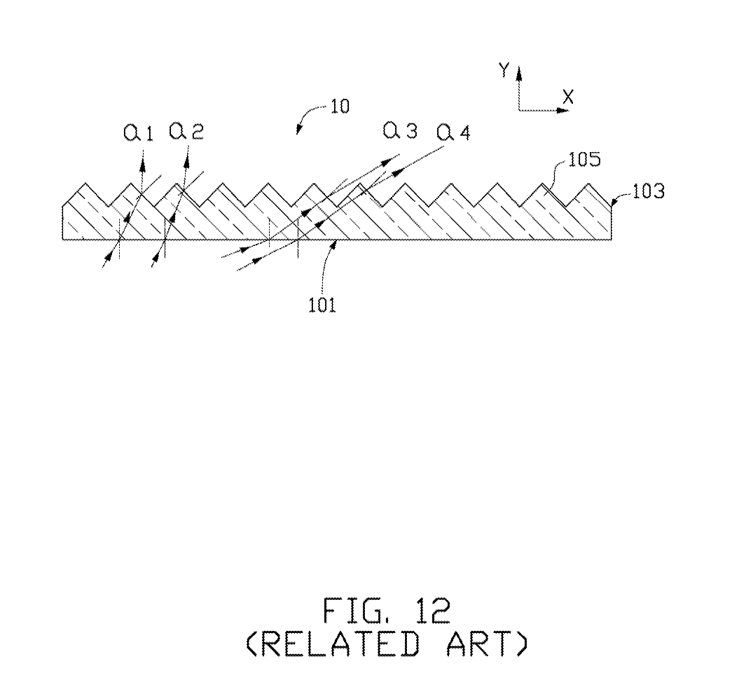

### DETAILED DESCRIPTION

Reference will now be made to the drawings to describe various embodiments of the present light concentration device and the backlight module.

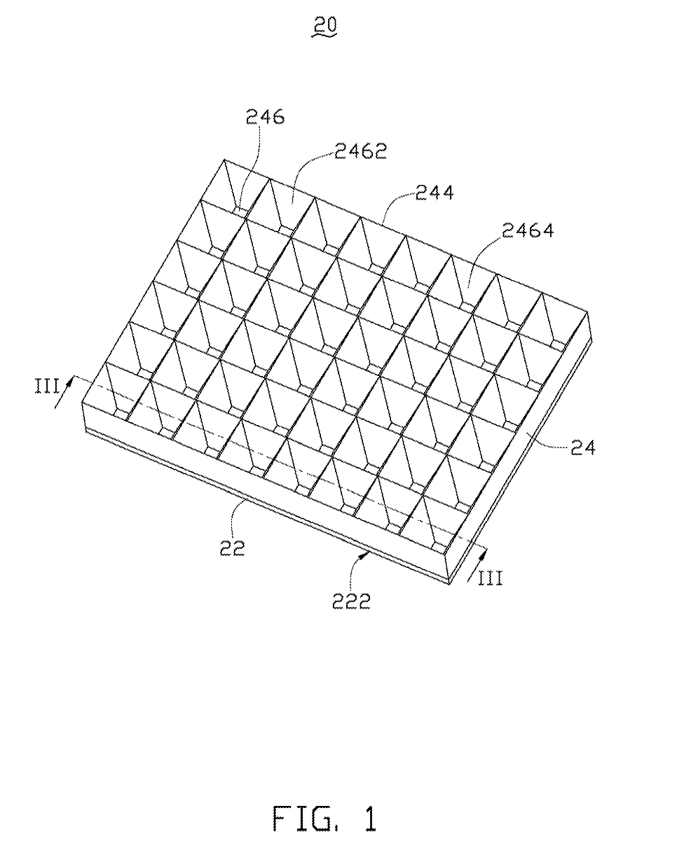

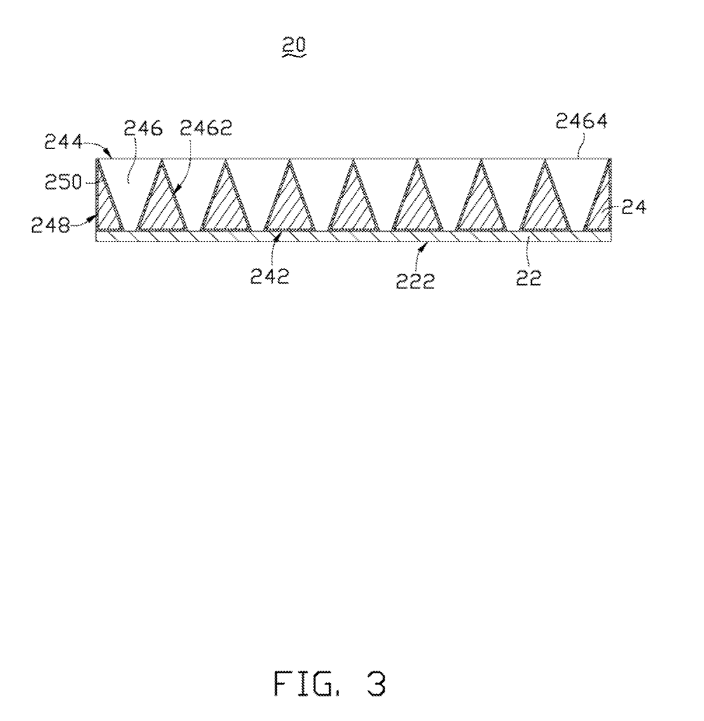

Referring to FIGS. 1 and 3, a light concentration device 20 in accordance with a first exemplary embodiment includes a base plate 22 and a light concentration plate 24 attached to the base plate 22. The light concentration device 20 is for concentrating light to a small viewing angle.

The base plate 22 is rectangular, and includes a light incident surface 222 and a light output surface 224. The light incident surface 222 is arranged facing away from the light concentration plate 24. The light output surface 224 is arranged facing toward the light concentration plate 24. Each of the light incident surface 222 and the light output surface 224 is a flat surface. A material of the base plate 22 may be comprised of light-pervious plastic, such as polymethyl methacrylate (PMMA). The base plate 22 is for supporting the light concentration plate 24 and guiding light into the light concentration plate 24.

The light concentration plate 24 is rectangular, and has a size substantially the same as the base plate 22. The light concentration plate 24 has a first surface 242 and a second surface 244 facing away from the first surface 242. The first surface 242 is adjacent to the light output surface 224 of the base plate 22. The light concentration plate 24 defines a number of through holes 246 running through the first and second surfaces 242 and 244.

Referring to FIG. 3, the through holes 246 taper from the second surface 244 to the first surface 242. In this embodiment, each of the through holes 246 has a truncated rectangular pyramidal shape. Each through hole 246 is bounded by four trapezoidal surfaces 2462 in the light concentration plate 24. Preferably, the four trapezoidal surfaces 2462 form a same angle with respect to the first surface 242. The through holes 246 are arranged in an array. Each of the through holes 246 has a rectangular opening 2464 on the second surface 244. Preferably, the openings 2464 are square. The openings 2464 are arranged adjoining each other. In addition, the openings 2464 can be arranged in an array spaced apart from each other.

The light concentration device 20 further includes a reflective layer 250 coating on the first surface 242, the second surface 244, the trapezoidal surfaces 2462, and a peripheral side surface 248 interconnecting the first surface 242 and the second surfaces 244. The light concentration plate 24 can be comprised of a light-pervious or light-tight plastic, such as PMMA. The reflective layer 250 is a thin film made of a highly reflective material, such as aluminum or silver. The reflective layer 250 coated on the first surface 242 contacts the light output surface 224 of the base plate 22.

It is to be understood that the reflective layer 250 on the second surface 244 can be omitted. Also, the light concentration plate 24 can be made of a reflective material. Accordingly, it is unnecessary to coat the reflective layer 250 on the light concentration plate 24.

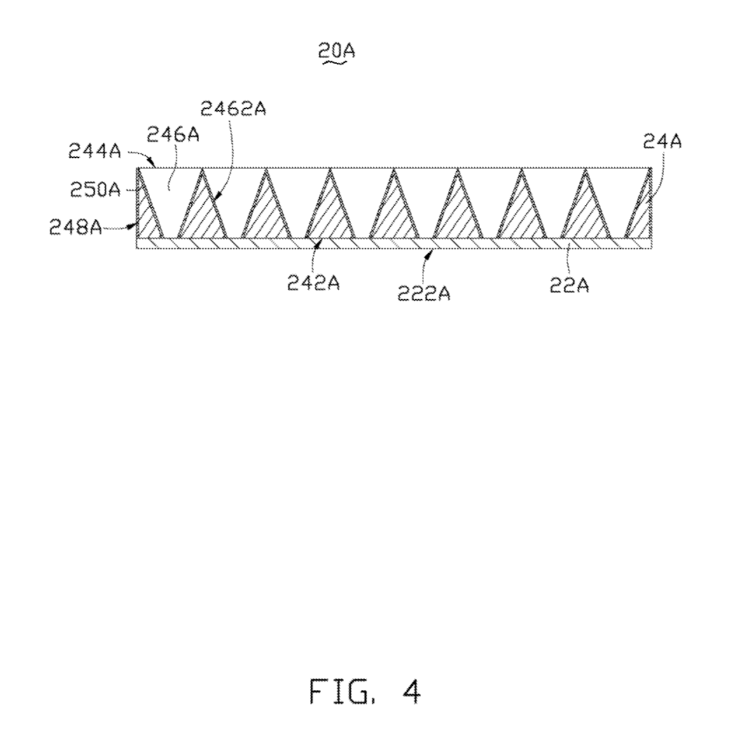

Referring to FIG. 4, a light concentration device 20A in accordance with a second exemplary embodiment is similar to the light concentration device 20. The light concentration device 20A includes a base plate 22A identical to the base plate 22 of the first exemplary embodiment, a light concentration plate 24A with an identical shape to the light concentration plate 24A of the first exemplary embodiment, and a reflective layer 250A. The light concentration plate 24a defines a number of through holes 246A, and has a first surface 242A, a second surface 244A facing away from the first surface 242A, a peripheral side surface 248A interconnecting the first surface 242A and the second surface 244A, and a number of trapezoidal surfaces 2462A cooperatively forming the through holes 246A. The first surface 242A is adjacent to and contacts the base plate 22A. The reflective layer 250A is coated on the second surface 244A, the peripheral side surface 248A, and the trapezoidal surfaces 2462A, and the first surface 242A is exposed.

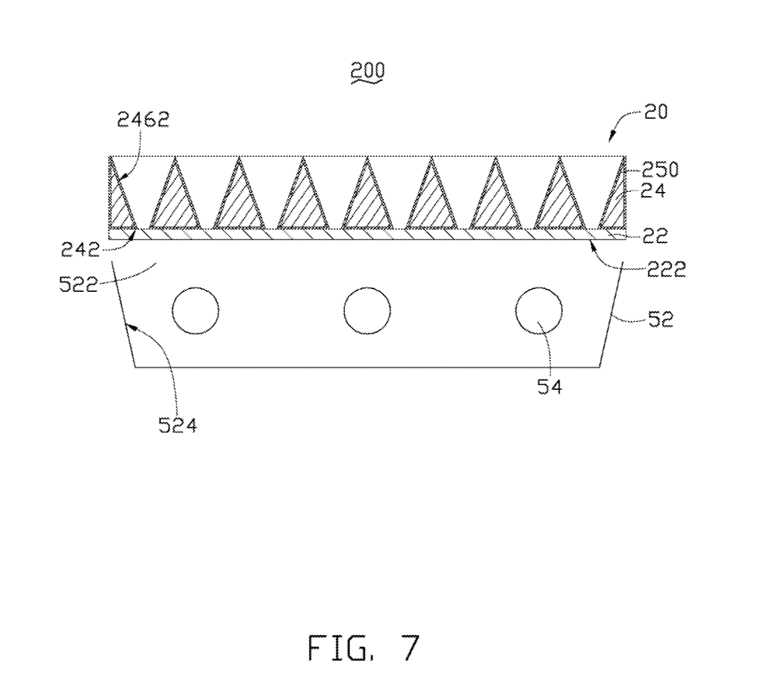

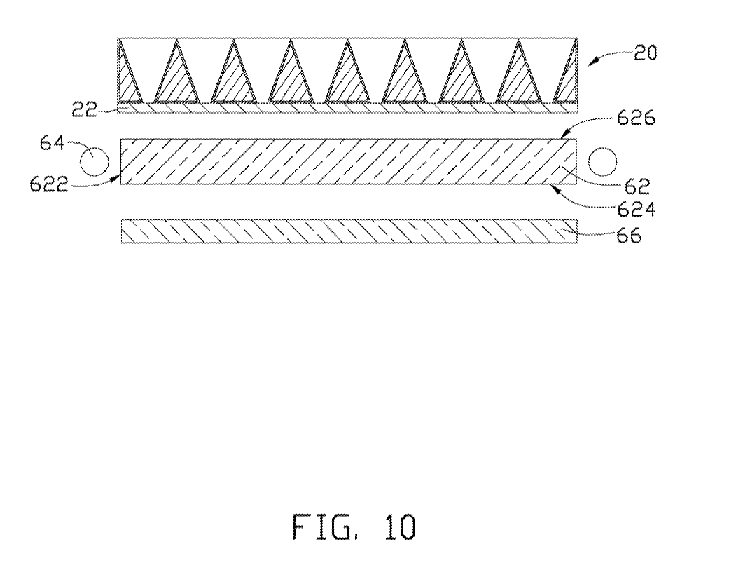

The light concentration plate 24A includes light-pervious material, such as PMMA, and the material of the reflective layer 250A can be same as the reflective layer 250 of the first exemplary embodiment. A reflective plate (such as a casing 52 in FIG. 7, or a reflective plate 66 in FIG. 10) can be arranged adjacent to the light incident surface 222A of the base plate 22A. Light entering into the light concentration plate 24A from the first surface 242A is reflected back to base plate 22A by the reflective layer 250A. Then the reflective plate reflects the light, and then the light is reflected by the reflective layer 250A or passes through the through holes 246A. Finally, most of the light reflected by the reflective layer 250A passes through the through holes 246A. When the light concentration device 20A is applied to a backlight module, a reflective member may be arranged facing toward the peripheral side surface 248A. In such case, the reflective layer 250A on the side face 248A can be omitted.

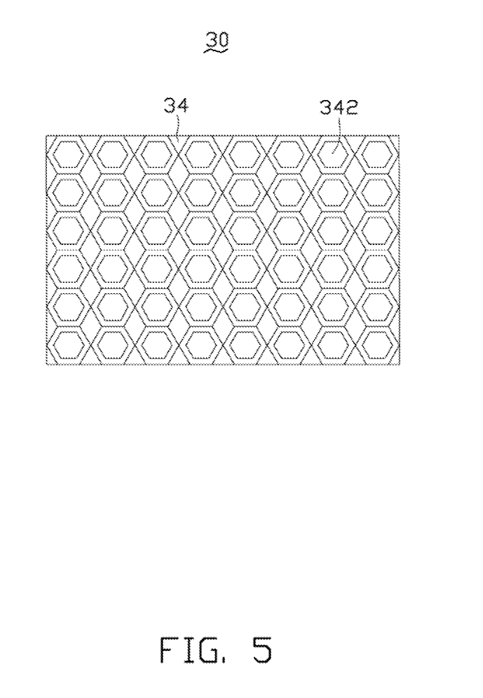

Referring to FIG. 5, a light concentration device 30 in accordance with a third exemplary embodiment is similar to the light concentration device 20. The distinguishing features are that a light concentration plate 34 of the light concentration device 30 includes a number of truncated six-sided pyramid shaped through holes 342 arranged in an array and adjoining each other. Also, the through holes 342 can be arranged in an array spaced apart from each other. In an alternative embodiment, the through holes 342 can be arranged in a honeycomb shape. In this embodiment, a reflective layer (not shown) on a first surface (not shown) or a second surface (not labeled) of the light concentration device 30 can also be omitted.

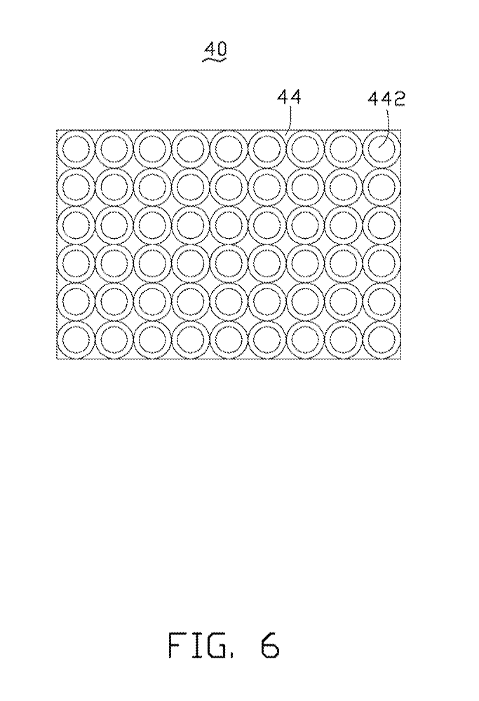

Referring to FIG. 6, a light concentration device 40 in accordance with a fourth exemplary embodiment is similar to the light concentration device 20. The distinguishing features are that a light concentration plate 44 of the light concentration device 40 includes a number of through holes 442 arranged in an array and adjoining each other. Each of the through holes 442 has a shape of frustum of a cone. In addition, the through holes 442 can be arranged in an array spaced apart from each other. In this embodiment, a reflective layer (not shown) on a first surface (not shown) or a second surface (not labeled) of the light concentration device 40 can also be omitted.

Referring to FIG. 7, a backlight module 200 in accordance with a fifth exemplary embodiment includes a casing 52, a number of light sources 54 and a light concentration device 20 of the first exemplary embodiment. The casing 52 has an opening 522, and a reflective inner surface 524. The light sources 54 are cold cathode fluorescent lamps (CCFLs), and are received in the casing 52. The light concentration device 20 is arranged over the light sources 54, and covers the opening 522 of the casing 52. The base plate 22 of the light concentration device 20 is arranged facing the light sources 54. It is to be understood that the light sources 54 can also be instead light emitting diodes (LEDs).

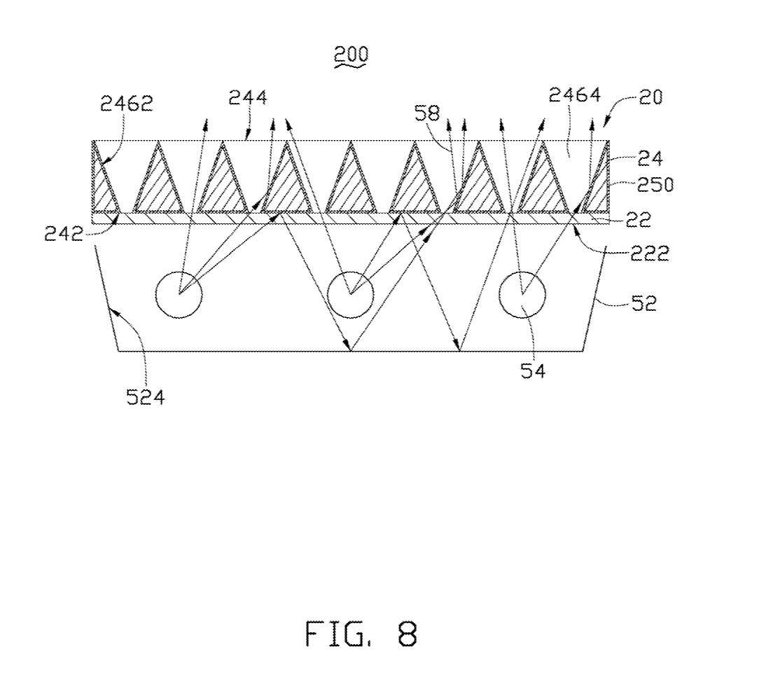

Referring to FIG. 8, light rays 58 emitted from the light sources 54 are transmitted through the base plate 22 of the light concentration device 20. A part of the light rays 58 pass through the through holes 246 directly from the first surface 242. Another part of the light rays 58 are reflected by the reflective layer 250 back to the casing, then are reflected by the inner surface 524 of the casing 52, and finally are transmitted through the through holes 246. As a whole, almost all of the light rays 58 are transmitted out of the backlight module 200 from the through holes 246. An amount of the light rays 58 passing through the through holes 246 is reflected by the reflective layer 250 coated on the trapezoidal surfaces 2462.

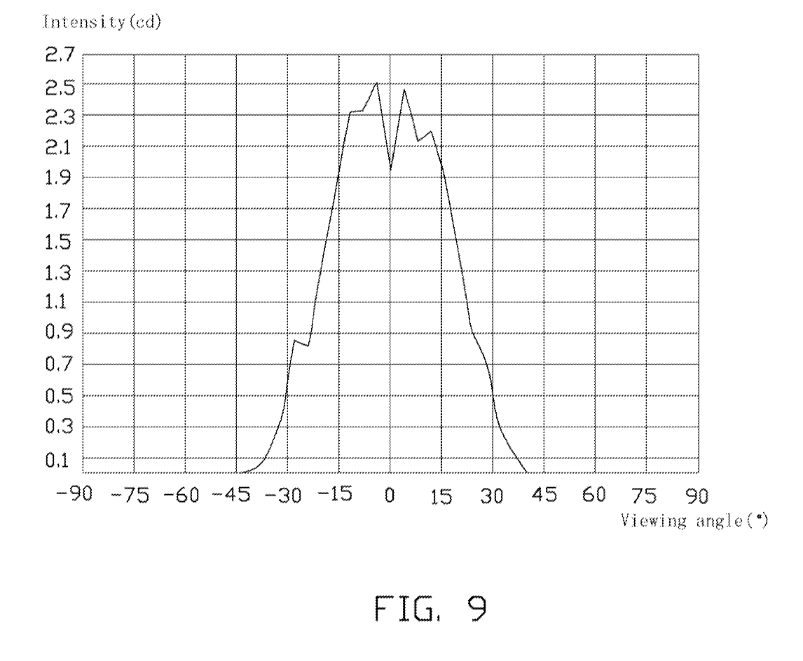

Because each of the through holes 246 tapers from the second surface 244 to the first surface 242, the light rays 58 emitting from the opening 2464 on the second surface 244 are restricted in a smaller viewing angle by the through hole 246. In detail, the light rays 58 emitting from the opening 2464 are transmitted to a predetermined viewing angle because of the reflection of the trapezoidal surfaces 2462. Each of the trapezoidal surfaces 2462 forms an included angle θ in respect to the first surface 242. In this embodiment, the included angle θ is equal to 60°. Referring to FIG. 9, a diagram of the light intensity of the light rays 58 emitting from the backlight module 200 of FIG. 7 is shown. The X axis denotes the viewing angle seen from the second surface 244 of the light concentration plate 24, wherein 0° denotes a direction perpendicular to the second surface 244. The Y axis denotes the light intensity of the light rays 58 emitting from the light concentration plate 24. It is seen that the light rays 58 emitting from the light concentration plate 24 are concentrated in a viewing angle range from about −30° to about +30°. That is, most of the light rays 58 are concentrated to a small viewing angle range by the light concentration device 20. The viewing angle of the light rays 58 can be changed by changing the included angle θ between the trapezoidal surfaces 2462 and the second surface 244. The greater the included angle θ is, the smaller the viewing angle of the light rays 58 emitting from the light concentration device 20.

In an alternative embodiment, a diffuser (not shown) can be arranged between the light sources 54 and the light concentration device 20. The base plate 22 can be omitted. In another alternative embodiment, the base plate 22 can be used instead of a diffuser. In addition, the light concentration device 20 of the backlight module 20 can be used instead of the light concentration device 20A, 30 or 40 as described in the respect second, third and fourth embodiments.

Referring to FIG. 10, a backlight module 300 in accordance with a sixth exemplary embodiment includes a light guide plate 62, two light sources 64, a reflective plate 66, and the light concentration plate 20 of the first exemplary embodiment. The light guide plate 62 has two opposite light incident surfaces 622, a bottom surface 624, and a light emitting surface 626. The bottom surface 624 and the light emitting surface 626 are arranged facing away from each other, and are adjacent to the two light incident surfaces 622. The light sources 64 are CCFLs, and are respectively arranged adjacent to the two light incident surfaces 622. The reflective plate 66 is arranged facing the bottom surface 624. The light concentration device 20 is arranged facing the light emitting surface 626, and the base plate 22 of the light concentration device 20 is adjacent to the light emitting surface 626. The light sources 64 emit light into the light guide plate 62. Then the light is guided to the light concentration device 20 or the reflective plate 66. The light concentration device 20 can concentrate the light in a similar manner to the fifth exemplary embodiment.

The light sources 64 can be LEDs instead. In addition, the light source 64 can be arranged adjacent to just one of the incident surfaces 622. The light guide plate 62 can also be omitted. In addition, the light concentration device 20 can also be used instead of the light concentration device 20A, 30 or 40 as described in the respective second, third and fourth embodiments.

Finally, it is to be understood that the above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

What is claimed is:

1. A light concentration device, comprising:
a light concentration plate having a first surface and a second surface facing away from the first surface, the light concentration plate defining a plurality of through holes running through the first surface and the second surface, the light concentration plate having a plurality of inner surfaces in the respective through holes, the through holes each tapering from the second surface to the first surface, the inner surfaces and at least one of the first and second surfaces being reflective surfaces.

2. The light concentration device of claim 1, wherein a shape of the through holes is selected from the group consisting of a truncated pyramid and a frustum of a cone.

3. The light concentration device of claim 2, wherein each of the through holes has a truncated rectangular pyramidal shape.

4. The light concentration device of claim 3, wherein the through holes are arranged in an array.

5. The light concentration device of claim 1, further comprising a reflective film covering each of the inner surfaces.

6. The light concentration device of claim 5, wherein the reflective film covers at least one of the first and second surfaces.

7. The light concentration device of claim 6, wherein the light concentration plate includes a peripheral side surface connected between the first and second surfaces, the reflective film covering the peripheral side surface.

8. The light concentration device of claim 7, further comprising a base plate attached to the first surface of the light concentration plate.

9. A backlight module, comprising:
a light concentration device of claim 1,
a reflective member facing toward the first surface of the light concentration device; and
a light providing member arranged between the light concentration device and the reflective member for providing light to the first surface.

10. The backlight module of claim 9, wherein the reflective member comprises a casing with an opening opening toward the first surface, the reflective member having a reflective inner surface, the light providing member comprises a plurality of light sources for emitting the light to the first surface.

11. The backlight module of claim 9, wherein the reflective member is a reflective plate, the light providing member comprising a light guide plate and a light source, the light guide plate comprising a bottom surface facing the reflective plate, a light output surface facing toward the first surface, and a light incident surface interconnected between the bottom surface and the light output surface, the light source being arranged adjacent to the light incident surface.

12. The backlight module of claim 9, wherein a shape of the through holes of the light concentration plate is selected from a group consisting of a truncated pyramid and a frustum of a cone.

13. The backlight module of claim 12, wherein each of the through holes has a truncated rectangular pyramidal shape.

14. The backlight module of claim 13, wherein the through holes are arranged in an array.

15. The backlight module of claim 14, wherein the light concentration device further comprising a base plate attached to the first surface of the light concentration plate.

16. A light concentration device comprising:
a plate having a first surface and a second surface facing away from the first surface, the plate defining a plurality of through holes running through the first surface and the second surface, the plate having a plurality of inner surfaces in the respective through holes, the through holes each tapering from the second surface to the first surface; and
a reflecting film covering the inner surfaces.
